(19) United States
(12) Patent Application Publication
(10) Pub. No.: US 2003/0118903 A1
(43) Pub. Date: Jun. 26, 2003

(54) Closed type battery

(75) Inventor: Tetsuhiro Ogaku, Utsunomiya-Shi (JP)

Correspondence Address: ARMSTRONG,WESTERMAN & HATTORI, LLP, 1725 K STREET, NW, SUITE 1000, WASHINGTON, DC, 20006, US

(73) Assignee: NEC TOKIN TOCHIGI, LTD., Utsunomiya-Shi (JP)

(21) Appl. No.: 10/327,120

(22) Filed: Dec. 24, 2002

(30) Foreign Application Priority Data
Dec. 25, 2001 (JP) 2001-392259

(51) Int. Cl. H01M 2/08; H01M 2/30

(52) U.S. Cl. 429/181; 429/184; 429/211

(57) ABSTRACT

The invention provides a closed type battery wherein there is no need of joining a tab joined to a battery element and an external circuit connection lead to an electrode terminal provided on a battery can via an insulating member. After the battery element is received in the battery can, a tab joined to the battery element is inserted through a tab sleeve formed integrally with a metal sheet of the battery header. In this state, the battery header is attached over an opening in the battery can, and the junction of the battery header and the battery can is sealed up by laser welding. Finally, an insulating member is inserted over the inside surface of the sleeve, which is then caulked.

### BACKGROUND OF THE INVENTION

The present invention relates generally to a closed type battery assembled using a metal can as an outer casing member, and more particularly to a closed type battery characterized by an electrode connection terminal that is opposite in polarity to a battery can.

In lithium ion batteries used as power sources for portable equipments, flexible members such as synthetic resin films are used as outer casing materials for battery cans. Batteries using battery cans are now widely used because of being resistant to impacts from outside and excelling in sealing properties.

In the batteries using a battery can, the battery can is used as one electrode terminal of given polarity while another electrode terminal is formed on an outer casing member via an insulating member. Generally, the latter electrode terminal is formed on a battery header via an insulating member while the header is mounted over an opening in the battery can.

After a battery element is received in the battery can having such structure, a tab connected to the battery element is electrically connected to the electrode terminal of the battery header by means of resistance welding, laser welding or the like. Then, the battery header is mounted over the opening in the battery can and, finally, the junction of the wall surface of the battery can and the battery header is sealed up by means of laser welding or the like.

FIGS. 8(A) and 8(B) are illustrative of one example of the electrode terminal of a closed type battery. FIG. 8(A) is a perspective view of a closed type battery of rectangular shape and FIG. 8(B) is a sectional view taken on line A-A′ of FIG. 8(A).

A battery header 3 is mounted over an opening in the upper portion of a battery can 2 of a closed type battery 1, and a tab 5 that is connected to one electrode of a battery element 4 received in the battery can is joined to an electrode-leading pin 14 of an electrode terminal 6. The electrode-leading pin 14 is insulated from a metal sheet of the battery header by an outer insulating sheet 16 and an inner insulating sheet 17 mounted onto a through-hole formed through a metal sheet 15 of the battery header 3. On the upper surface of the outer insulting sheet there is provided an electrode-drawing sheet 18 to which an external circuit connection lead wire is joined.

A battery header is produced by attaching an external insulating sheet, an internal insulating sheet and an electrode-drawing sheet onto a through-hole formed through a metal sheet, inserting an electrode-drawing pin through the assembly from the internal insulating sheet side, and caulking the electrode-drawing pin.

In such batteries, the tab joined to the battery element is joined to the electrode-leading pin of the electrode terminal by means of laser welding, resistance welding or the like. Problems with some batteries are that the sealing of the electrode terminal becomes worse due to thermal influences from the electrode-leading pin on the insulating members forming the electrode terminal, resulting in electrolyte leakage.

JP 2001-193485(A) discloses a closed type battery wherein the sealed electrode terminal is provided with a cylindrical projection extending outwardly from the main surface, thereby reducing influences of heat. However, the battery header has an electrode terminal, and so it is required to join a tab and an external connection lead wire to that electrode terminal. In addition, after the electrode terminal is formed, the electrode terminal and the battery can must be sealed up by laser welding. Thus, this closed type battery is less than satisfactory in terms of prevention of thermal influences.

### BRIEF DESCRIPTION OF THE DRAWINGS

FIG. 1 is illustrative of one embodiment of the closed type battery according to the invention.

FIGS. 2(A), 2(B), 2(C), 2(D) and 2(E) are illustrative of one exemplary process of producing the battery shown in FIG. 1.

FIG. 3 is illustrative of another embodiment of the closed type battery according to the invention.

FIGS. 4(A), 4(B), 4(C), 4(D) and 4(E) are illustrative of one exemplary process of producing the battery shown in FIG. 3.

FIG. 5 is illustrative of yet another embodiment of the invention.

FIG. 6 is illustrative of one exemplary process of producing the battery shown in FIG. 5.

FIGS. 7(A), 7(B) and 7(C) are illustrative of one embodiment of the battery header used with the closed type battery according to the invention.

FIGS. 8(A) and 8(B) are illustrative of one embodiment of the electrode terminal of a closed type battery.

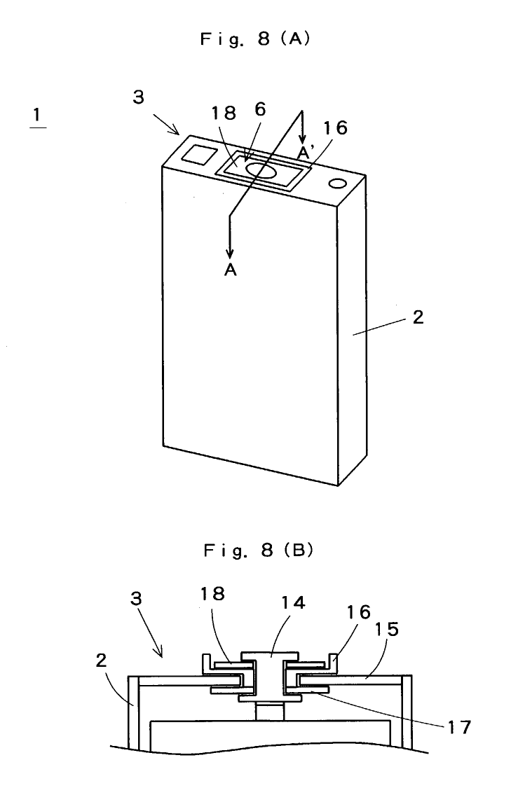

### SUMMARY OF THE INVENTION

The present invention provides a closed type battery comprising a tab joined to a battery element, wherein said tab is inserted through a tab sleeve formed integrally with a metallic outer member while an insulting member is sandwiched between the tab and the inside surface of the sleeve.

The invention provides a closed type battery wherein the tab sleeve projects outwardly from an outer wall surface.

The invention provides a closed type battery wherein the tab sleeve is formed in a recess provided in the outer wall surface in an outwardly projecting manner.

The invention provides a closed type battery wherein the tab sleeve projects from the wall surface into the battery.

The invention provides a closed type battery wherein the tab sleeve is formed on a battery header attached over an opening in a battery can.

### DESCRIPTION OF THE PREFERRED EMBODIMENT

The present invention relates to a closed type battery using a metal can as an outer casing member. Regarding such a battery, it has been found that there is deterioration in the sealed portion of an electrode terminal provided for drawing an electrical connection tab opposite in polarity to an outer casing member joined to a battery element, and this deterioration is caused by heat generated on welding of the tab to the electrode terminal, heat generated on sealing of a battery header mounted over an opening in a battery can and the battery can, slight misalignments of components occurring on assembling of electrode terminal portions, etc. It has then been found that by eliminating factors responsible for such deterioration, a closed type battery can be kept in a well-sealed state.

It has thus been found that such a closed type battery can be achieved by dispensing with an electrode terminal that is provided on the outside surface of the battery can, i.e., drawing an electrical connection tab connected to the battery element out of the wall surface of the battery can and sealing up a portion where the tab emerges out of the wall surface of the battery can.

The present invention is now explained with reference to the accompanying drawings.

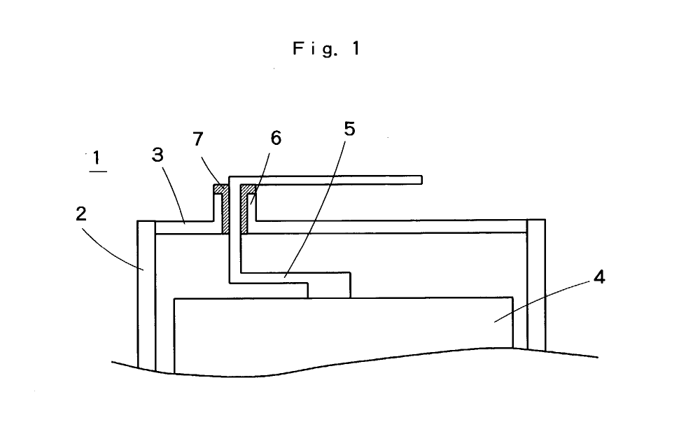

FIG. 1 is a sectional view of one embodiment of the closed type battery according to the invention, showing in section an upper portion thereof.

A closed type battery shown generally at 1 comprises a battery can 2 having an upper opening and a battery header 3 joined over the upper opening. Joined to one electrode of a battery element 4, a tab 5 extends through a tab sleeve 6 formed integrally with a metal sheet of the battery header 3. The tab sleeve 6 is provided on its inside surface with an insulating member 7. The tab sleeve 6 is caulked from its outside surface to seal up the tab and the tab sleeve 6.

By inserting the tab through the battery header portion in this way, it is possible to make an electrical connection without joining the tab to a separately provided electrode terminal and so dispense with any welding of the tab to that electrode terminal.

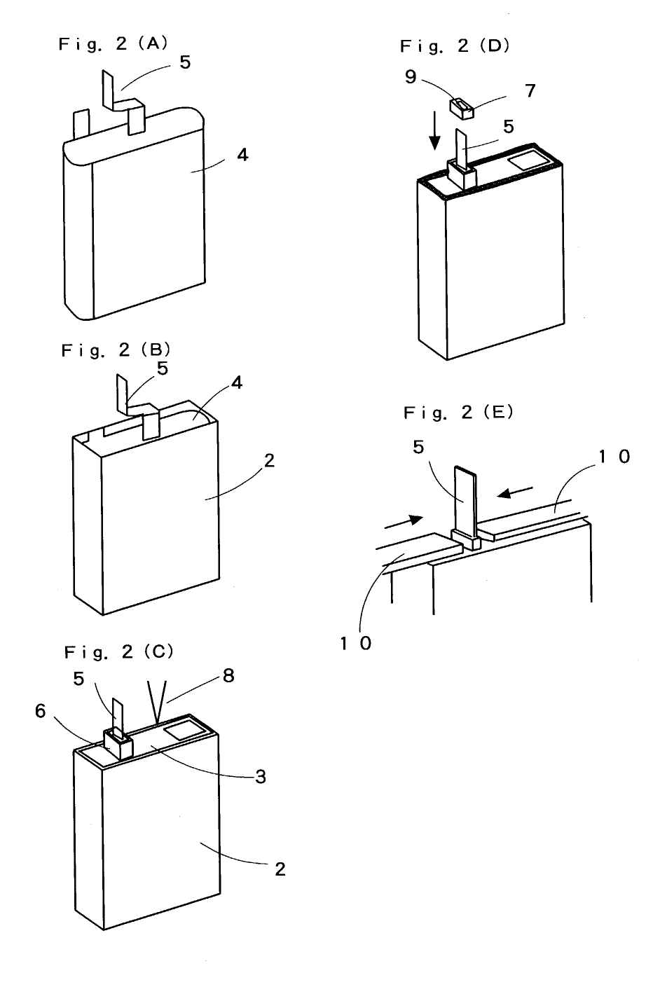

FIGS. 2(A), 2(B), 2(C), 2(D) and 2(E) are illustrative of one example of how to produce the battery shown in FIG. 1.

As shown in FIG. 2(A), one tab 5 connected to the battery element 4 is configured in conformity with the shape of the battery header mounted over the opening in the battery can. The tab may be drawn either parallel with or vertically to the thickness direction of the battery. In general, however, it is preferable to draw the tab in the direction parallel with the thickness direction of the battery, because the tab can easily be connected to safety means such as a PTC element mounted on the side of the battery.

Then, as shown in FIG. 2(B), the battery element 4 with the tab 5 connected thereto is received in the battery can 2.

Then, as shown in FIG. 2(C), the tab 5 is inserted through the tab sleeve 6 integrated with the battery header 3, and the battery header 3 is mounted over the opening in the battery can, after which the junction of the battery can and the battery header is welded by a laser 8.

Then, as shown in FIG. 2(D), the insulating member 7 having a through-hole 9 for the tab 5 is inserted into the tab sleeve 6.

Finally, as shown in FIG. 2(E), the tab sleeve 6 is caulked by means of a jig 10, so that the closed type battery is sealed up.

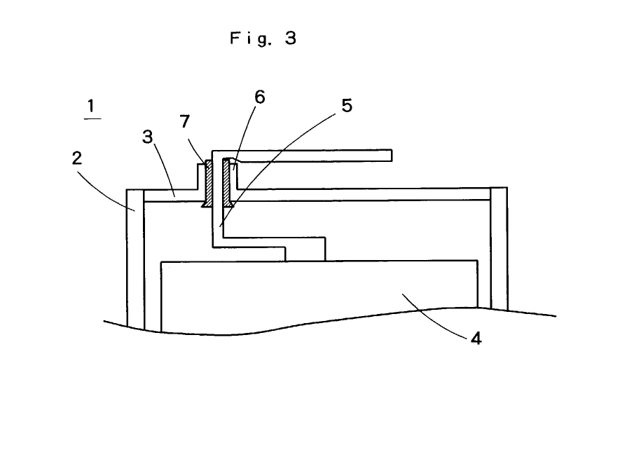

FIG. 3 is illustrative of another embodiment of the closed type battery of the invention, showing in section an upper portion thereof.

The battery header 3 is joined over an upper opening in the battery can 2 of the closed type battery 1, and the tab 5 joined to one electrode of the battery element 4 is inserted through the tab sleeve 6 formed integrally with a metal sheet of the battery header 3.

The tab sleeve 6 is provided on its inside surface with the insulating member 7, and then caulked from its outside surface to seal up the tab inserted through the same.

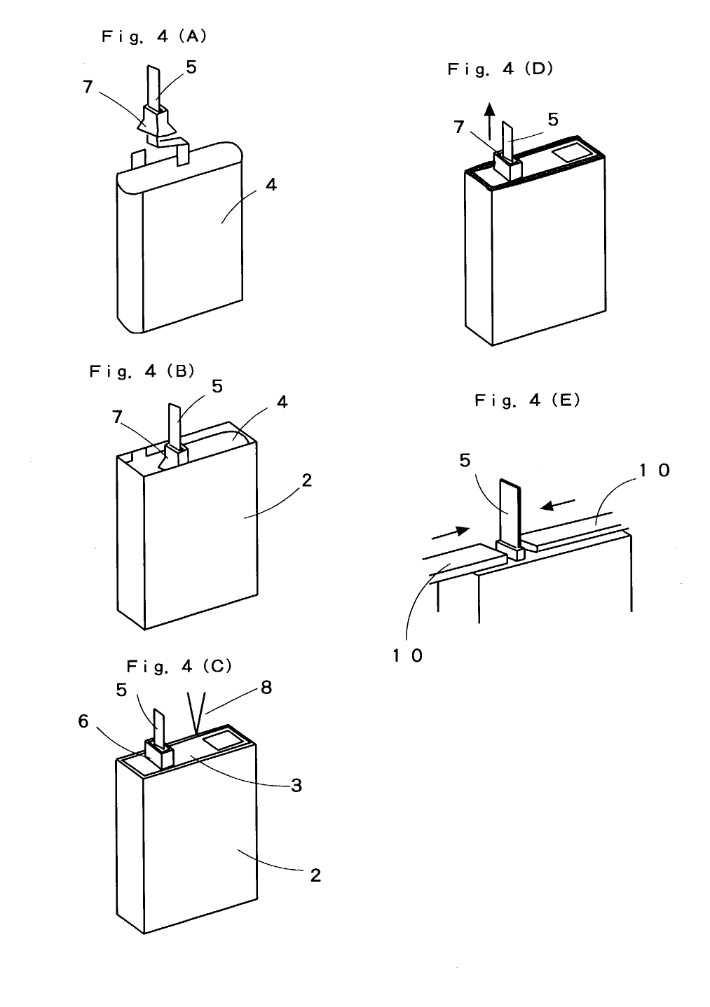

FIGS. 4(A), 4(B), 4(C), 4(D) and 4(E) are illustrative of one example of how to produce the battery shown in FIG. 3.

As shown in FIG. 4(A), one tab 5 of the battery element 4 is configured in conformity with the shape of the battery header, and the insulating member 7 is attached to the tab 5.

Then, as shown in FIG. 4(B), the tab 5 is inserted through the tab sleeve 6 formed integrally with the battery header 3.

Then, as shown in FIG. 4(C), the battery header 3 is placed over the opening in the battery can and, thereafter, the junction of the battery can and the battery header is welded by a laser 8.

Then, as shown in FIG. 4(D), the insulating member is attached to the tab sleeve with reliability while the tab 5 is drawn.

Finally, as shown in FIG. 4(E), the tab sleeve 6 is caulked by means of a jig 10, thereby sealing up the closed type battery.

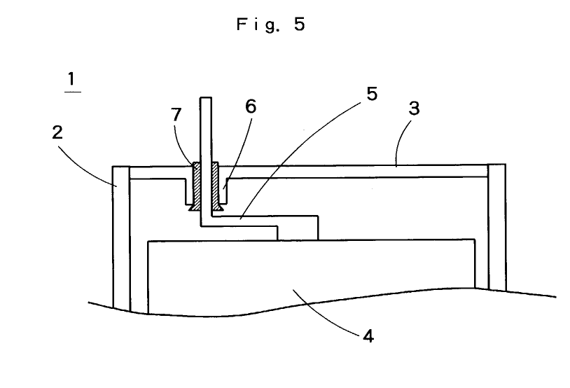

FIG. 5 is illustrative of yet another embodiment of the invention, showing in section an upper portion of the battery.

In the examples shown in FIGS. 1 to 4, the tab sleeve 6 provided on the battery header projects outwardly from the outer surface of the battery header 3. In the example shown in FIG. 5, however, the tab sleeve 6 projects from the battery header 3 into the battery, so that the amount of projection of parts from the battery header 3 is reduced.

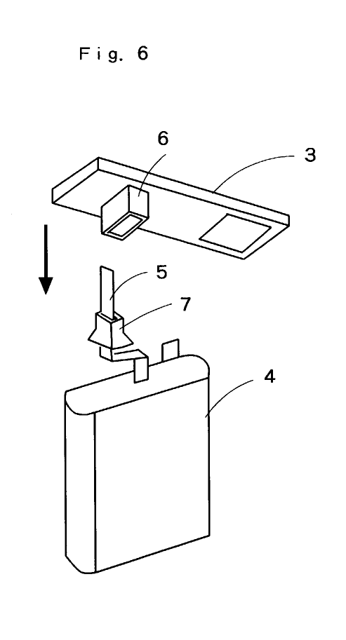

FIG. 6 is illustrative of how to produce the battery shown in FIG. 5.

As shown in FIG. 6, the insulating member 7 is attached to one tab 5 joined to the battery element 4. Then, the tab 5 is inserted through the tab sleeve 6 attached to the inside of the battery header 3, and the tab 5 is insulated from the inside surface of the tab sleeve 6 by the insulting member 7. Subsequently, the tab sleeve 6 is caulked from outside to seal up the same.

Then, the battery element 4 is received in the battery can 2, and the junction of the battery header and the battery can is welded by a laser.

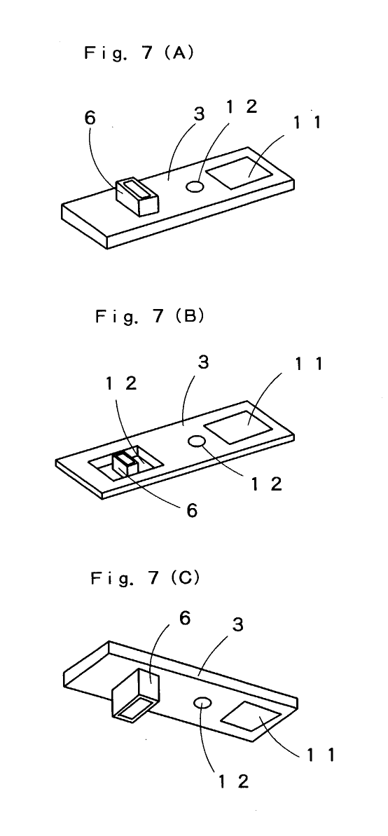

FIGS. 7(A), 7(B) and 7(C) are illustrative of the battery header of the closed type battery of the invention.

FIG. 7(A) shows that the tab sleeve 6 projects outwardly from the battery header. The battery header includes a pressure release valve 11 that is actuated in response to an abnormal rise in the battery pressure to release pressure, and this valve 11 is formed of a thinner portion of the header. The battery header also includes an electrolyte-pouring hole 12 through which an electrolyte is poured in the battery can and which is sealed up after the pouring of the electrolyte.

As shown in FIG. 7(B), the battery header 3 is recessed at 13 to receive the tab sleeve 6, so that the amount of projection of the tab sleeve 6 from the surface of the battery header 3 is reduced.

As shown in FIG. 7(C), a substantial part of the tab sleeve 6 is housed in the battery, so that the amount of projection of the sleeve 6 from the surface of the battery header 3 is reduced.

The tab sleeve provided on each battery header may be formed by press molding or the like at the step of making the battery header.

The present invention is applicable to every closed type battery using a battery can, and the battery can and header used may be formed of aluminum, its alloy, nickeled steel, stainless steel, etc.

The insulating member used to insulate the inside surface of the sleeve from the tab and keep the airtightness of the sleeve may be formed of thermoplastic resins such as polypropylene, thermoplastic fluorocarbon resins such as tetrafluoroethylene-perfluoroalkoxyethylene copolymers (PFA) and tetrafluoroethylene-hexafluoro-propylene copolymers (PEP), etc.

The present invention is now explained with reference to Example 1.

### EXAMPLE 1

A tab sleeve having inside dimensions of 3.5 mm×0.5 mm and a height of 1 mm was formed on a battery header having a long side of 29 mm and a short side of 5 mm in an outwardly projecting manner.

A tab joined to a battery element was configured in such a way as to conform to the shape of the tab sleeve provided on the battery header, and then inserted through the tab sleeve. Subsequently, the battery header was attached to a battery can followed by laser welding of the junction of the battery can and the battery header.

After an insulating member was inserted through the sleeve to insulate the inside surface of the sleeve from the tab, the sleeve was caulked by means of a caulking jig to seal up the sleeve. Finally, an electrolyte was poured through an electrolyte-pouring hole in the battery can, and the pouring hole was closed up.

All the prepared batteries were of good airtightness. Even after subjected to 1,000-hour accelerated tests at 60° C. and 95% RH, the batteries were all free from electrolyte leakage.

Thus, the present invention provides a closed type battery comprising a battery can, a battery header mounted over an opening in the battery can and a tab sleeve formed integrally with the battery header, wherein a tab joined to a battery element is inserted through the sleeve, an insulating member is inserted through the sleeve to insulate the inside surface of the sleeve from the tab, and the sleeve is caulked from outside. Thus, since there is no need of joining the tab and an external circuit connection lead to an electrode terminal mounted on the battery header, it is possible to prevent any deterioration by welding heat in the insulating member provided on the electrode terminal and, hence, keep the closed type battery in a well-sealed state.

What we claim is:

1. A closed type battery comprising a tab joined to a battery element, wherein said tab is inserted through a tab sleeve formed integrally with a metallic outer member while an insulting member is sandwiched between the tab and an inside surface of the sleeve.

2. The closed type battery according to claim 1, wherein the sleeve is sealed up by caulking.

3. The closed type battery according to claim 1, wherein the sleeve projects outwardly from an outer wall surface.

4. The closed type battery according to claim 2, wherein the sleeve projects outwardly from an outer wall surface.

5. The closed type battery according to claim 1, wherein the sleeve is formed in a recess provided in an outer wall surface in an outwardly projecting manner.

6. The closed type battery according to claim 2, wherein the sleeve is formed in a recess provided in an outer wall surface in an outwardly projecting manner.

7. The closed type battery according to claim 3, wherein the sleeve is formed in a recess provided in an outer wall surface in an outwardly projecting manner.

8. The closed type battery according to claim 4, wherein the sleeve is formed in a recess provided in an outer wall surface in an outwardly projecting manner.

9. The closed type battery according to claim 1, wherein the sleeve projects from a wall surface into the battery.

10. The closed type battery according to claim 2, wherein the sleeve projects from a wall surface into the battery.

11. The closed type battery according to claim 1, wherein the sleeve is formed on a battery header mounted over an opening in a battery can.
